(19) United States
(12) Patent Application Publication
(10) Pub. No.: US 2010/0161283 A1
(43) Pub. Date: Jun. 24, 2010

(54) STRUCTURAL HEALTH MONITORING NETWORK

(76) Inventors: Xinlin QING, Cupertino, CA (US); Sourav BENERJEE, Santa Clara, CA (US); Chang ZHANG, Santa Clara, CA (US); Shawn BEARD, Livermore, CA (US); Irene LI, Stanford, CA (US); Fu-Kuo CHANG, Stanford, CA (US)

Correspondence Address: Innovation Counsel LLP, 21771 Stevens Creek Blvd, Ste. 200A, Cupertino, CA, 95014, US

(21) Appl. No.: 12/718,817

(22) Filed: Mar. 5, 2010

Related U.S. Application Data
(63) Continuation-in-part of application No. 11/543,185, filed on Oct. 3, 2006.

(51) Int. Cl. G06F 15/00

(52) U.S. Cl. 702/188

(57) ABSTRACT

A networked configuration of structural health monitoring elements. Monitoring elements such as sensors and actuators are configured as a network, with groups of monitoring elements each controlled by a local controller, or cluster controller. A data bus interconnects each cluster controller with a router, forming a networked group of “monitoring clusters” connected to a router. In some embodiments, the router identifies particular clusters, and sends commands to the appropriate cluster controllers, instructing them to carry out the appropriate monitoring operations. In turn, the cluster controllers identify certain ones of their monitoring elements, and direct them to monitor the structure as necessary. Data returned from the monitoring elements is sent to the cluster controllers, which then pass the information to the router. Other embodiments employ multiple sensor groups directly connected to a central controller, perhaps with distributed local control elements. Methods of operation are also disclosed.

This application is a continuation-in-part of U.S. patent application Ser. No. 11/543,185, filed on Oct. 3, 2006, the entire contents of which are hereby incorporated by reference.

### BRIEF DESCRIPTION OF THE INVENTION

This invention relates generally to structural health monitoring. More specifically, this invention relates to structural health monitoring networks.

### BACKGROUND OF THE INVENTION

Current structural health monitoring systems are designed to carry out diagnostics and monitoring of structures. As such, they typically confer many advantages, such as early warning of structural failure, and detection of cracks or other problems that were previously difficult to detect.

However, these systems are not without their disadvantages. For example, many current structural health monitoring systems are relatively simple systems that have a number of sensors connected to a single controller/monitor. While such systems can be effective for certain applications, they lack flexibility and are often incapable of scaling to suit larger or more complex applications. For instance, a single controller is often unsuitable for controlling the number of monitoring elements (e.g., sensors, actuators, etc.) required to monitor large structures. Accordingly, continuing efforts exist to improve the configuration and resulting performance of structural health monitoring networks, so that they can be more flexibly adapted to different health monitoring applications.

### SUMMARY OF THE INVENTION

The invention can be implemented in numerous ways, including as an apparatus and as a method. Several embodiments of the invention are discussed below.

In one embodiment, a structural health monitoring system comprises a plurality of monitoring clusters, each monitoring cluster having a plurality of monitoring elements each configured to monitor the health of a structure, and a cluster controller in communication with the plurality of monitoring elements and configured to control an operation of the plurality of monitoring elements. The system also includes a data bus in communication with each monitoring cluster of the plurality of monitoring clusters. Furthermore, the cluster controllers are each configured to receive from the data bus control signals for facilitating the control of the monitoring elements, and to transmit along the data bus data signals from the monitoring elements.

In another embodiment, a structural health monitoring network comprises a plurality of monitoring clusters, each monitoring cluster having a plurality of monitoring elements each configured to monitor the health of a structure. The network also includes a router in communication with each monitoring cluster of the plurality of monitoring clusters. The router is configured to select ones of the monitoring clusters, to transmit instructions to the selected monitoring clusters so as to facilitate a scanning of the structure by the selected monitoring clusters, and to receive information returned from the selected monitoring clusters, the information relating to the health of the structure.

In another embodiment, a method of operating a structural health monitoring system having routers each in communication with one or more monitoring clusters, the monitoring clusters each having one or more monitoring elements and a cluster controller in communication with the monitoring elements and the router, comprises receiving instructions to monitor a structure. The method also includes selecting ones of the monitoring clusters according to the instructions. Also included are directing the cluster controllers of the selected monitoring clusters to perform one or more monitoring operations, and receiving from the cluster controllers of the selected monitoring clusters information detected from the one or more monitoring operations.

In another embodiment, a structural health monitoring system comprises a plurality of sensor networks, each sensor network having a plurality of sensing elements, as well as a diagnostic unit. The diagnostic unit comprises a signal generation module configured to generate first electrical signals for generating stress waves in a structure, and a data acquisition module configured to receive second electrical signals generated by the sensing elements, the second electrical signals corresponding to the generated stress waves. The diagnostic unit is programmed to select ones of the sensor networks so as to designate selected sensor networks and, for each selected sensor network, to select a first set of sensing elements and a second set of sensing elements, to direct the first electrical signals exclusively to the first set of sensing elements, and to receive the second electrical signals exclusively from the second set of sensing elements.

In another embodiment, a structural health monitoring system comprises a plurality of sets of sensing elements and a plurality of flexible substrates, each set of sensing elements affixed to a different one of the flexible substrates. The system also includes a signal generation module configured to generate first electrical signals for generating stress waves in a structure, and a data acquisition module configured to receive second electrical signals generated by the sensing elements, the second electrical signals corresponding to the generated stress waves. Also included is a set of switches in electrical communication with the signal generation module, the data acquisition module, and each set of sensing elements. Each switch of the set of switches is individually operable to place one sensing element in electrical communication with at least one of the signal generation module and the data acquisition module. Further included is a processing unit having a computer-readable memory storing instructions. The instructions comprise a first set of instructions to select ones of the sets of sensing elements, so as to designate selected sensing elements, and a second set of instructions to select a first sensor group from the selected sensing elements, and to select a second sensor group. The instructions also include a third set of instructions to direct the set of switches to place only the sensing elements of the first sensor group in electrical communication with the signal generation module, so as to direct the first electrical signals to the sensing elements of the first sensor group. Also included is a fourth set of instructions to direct the set of switches to place only the sensing elements of the second sensor group in electrical communication with the data acquisition module, so as to direct ones of the second electrical signals generated by the sensing elements of the second sensor group to the data acquisition module.

In another embodiment, a method of performing structural health monitoring with a system having a plurality of sensor networks each affixed to a structure, each sensor network having a plurality of sensing elements affixed to the structure, comprises:

(a) selecting one of the sensor networks;

(b) selecting first sensing elements of the selected sensor network;

(c) selecting second sensing elements;

(d) transmitting diagnostic signals only to the first sensing elements, so as to generate diagnostic stress waves in the structure;

(e) receiving monitoring signals from the second sensing elements, the monitoring signals corresponding to the generated diagnostic stress waves;

(f) analyzing data corresponding to the received monitoring signals, so as to determine a health of an area of the structure corresponding to the selected sensor network; and

(g) after (e), selecting a different one of the sensor networks, and repeating (b)-(f) in order.

In another embodiment, a structural health monitoring system comprises a plurality of sensor networks, each sensor network having a plurality of sensing elements; a central controller; and a plurality of local controllers, each in electrical communication with the central controller and one of the sensor networks. Each local controller includes at least one of a signal generation module configured to generate first electrical signals for generating stress waves in a structure, and a data acquisition module configured to receive second electrical signals generated by the sensing elements of the associated one sensor network. The central controller is programmed to select ones of the local controllers and, for each selected local controller, to receive data corresponding to the second electrical signals from the selected local controllers.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention, together with further objects and advantages thereof, may best be understood by reference to the following description taken in conjunction with the accompanying drawings in which:

FIG. 1 illustrates an exemplary structural health monitoring network constructed in accordance with an embodiment of the present invention.

FIG. 2 illustrates an exemplary cluster controller for use with the structural health monitoring networks of the invention.

FIG. 3A illustrates a first configuration of a router for use with the structural health monitoring networks of the invention.

FIG. 3B illustrates a second configuration of a router for use with the structural health monitoring networks of the invention.

FIG. 4A illustrates a central controller for use with the structural health monitoring networks of the invention, and configured as a portable computer.

FIG. 4B illustrates a central controller configured as a desktop computer.

FIG. 4C illustrates a central controller configured as a server computer.

FIGS. 5-7 illustrate exemplary structural health monitoring systems constructed in accordance with further embodiments of the present invention.

FIGS. 8-10 illustrate exemplary distributions of data processing, excitation and data acquisition, and switch functions in the systems of FIGS. 5-7.

FIGS. 11, and 12A-B illustrate exemplary structural health monitoring systems constructed in accordance with further embodiments of the present invention.

FIG. 13 conceptually illustrates information entered into systems of various embodiments, for use in operation of the systems.

FIG. 14 illustrates an exemplary sequence of data acquisition, damage analysis, and results transmission operations conducted by various systems of the invention.

FIG. 15 illustrates exemplary queuing of results from operation of various systems of the invention.

Like reference numerals refer to corresponding parts throughout the drawings. Also, it is understood that the depictions in the figures are diagrammatic and not necessarily to scale.

### DETAILED DESCRIPTION OF EMBODIMENTS OF THE INVENTION

In one embodiment of the invention, monitoring elements such as sensors and actuators are configured as a network, with groups of monitoring elements each controlled by a local controller, or cluster controller. A data bus interconnects each cluster controller with a router, forming a networked group of “monitoring clusters” connected to a router. In some embodiments, the router identifies particular clusters, and sends commands to the appropriate cluster controllers, specifying certain monitoring elements and instructing the cluster controllers to carry out the appropriate monitoring operations with those elements. Data returned from the monitoring elements is sent to the cluster controllers, which then pass the information to the router.

The invention also includes embodiments in which each such network (i.e., a group of monitoring clusters and their associated router) is linked over a common data line to a central controller. That is, the central controller is set up to control a number of networks. In this manner, the central controller identifies certain networks for performing structural health monitoring operations, and sends commands to the routers of those networks directing them to carry out the operations. When each router receives these commands, it proceeds as above, directing its monitoring clusters to carry out the monitoring operations and receiving the returned data. The routers then forward this data to the central controller for processing and analysis, sometimes conditioning the signals first. Data returned from the monitoring elements is sent to the routers via the cluster controllers as above, then on to the central controller.

The invention further includes embodiments that employ multiple sensor groups directly connected to a central controller, perhaps with distributed local control elements. In some such embodiments, no bus structure or router is employed, but rather a bank of switches controlling direct connections between the diagnostic electronics and the sensing elements of the sensor groups/monitoring clusters. Methods of operation are also disclosed.

In embodiments of the invention, well-known components such as filters, transducers, and switches are sometimes employed. In order to prevent distraction from the invention, these components are represented in block diagram form, omitting specific known details of their operation. One of ordinary skill in the art will understand the identity of these components, and their operation.

It will also be recognized that the monitoring elements, and at least portions of the local controllers and routers, can be affixed to a flexible dielectric substrate for ease of handling and installation. These substrates and their operation are further described in U.S. Pat. No. 6,370,964 to Chang et al., which is hereby incorporated by reference in its entirety and for all purposes. Construction of the substrates is also explained in U.S. patent application Ser. No. 10/873,548, filed on Jun. 21, 2004, now U.S. Pat. No. 7,413,919, which is also incorporated by reference in its entirety and for all purposes. It should be noted that the present invention is not limited to the embodiments disclosed in the aforementioned U.S. patent application Ser. No. 10/873,548. Rather, any network of sensors and actuators can be employed, regardless of whether they are incorporated into a flexible substrate or not.

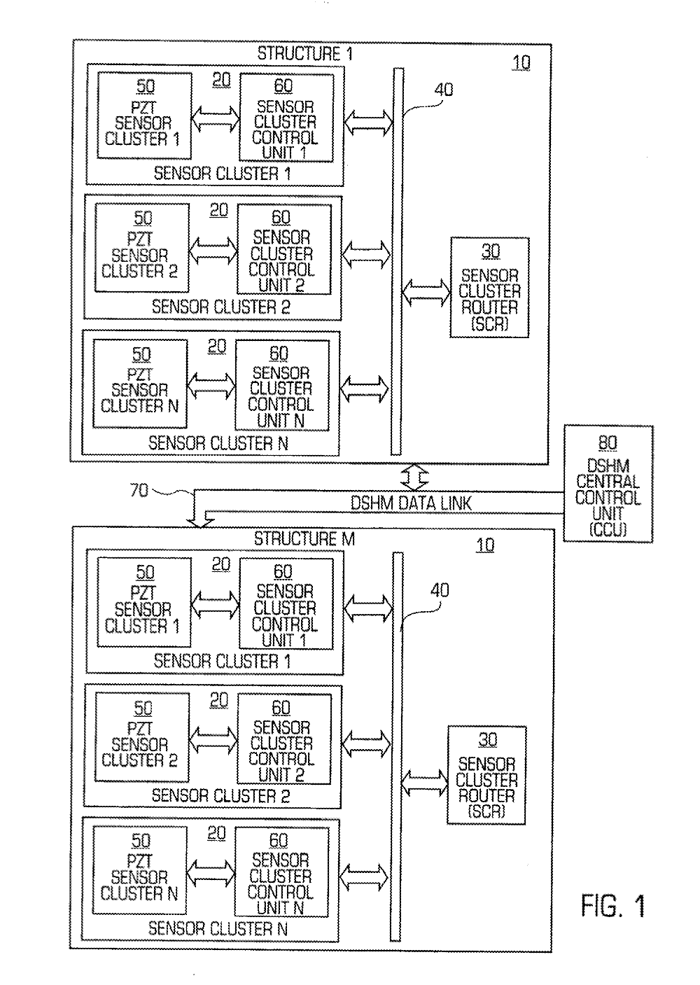

FIG. 1 illustrates an exemplary structural health monitoring network constructed in accordance with an embodiment of the present invention. A number of sensor networks 10 are configured as a group of monitoring clusters 20 and a router 30, interconnected by a data bus 40. Each monitoring cluster 20 has a cluster of monitoring elements 50, such as sensors and/or actuators, controlled by a local controller or cluster controller 60. Each sensor network 10 thus has a number of clusters of sensors, each controlled by a cluster controller 60. The cluster controllers 60 are in turn controlled by a router 30 that selects individual monitoring clusters 20 and transmits instructions to their cluster controllers 60 across the data bus 40.

In operation, the monitoring elements 50 are attached, or otherwise placed in proximity, to a structure so as to monitor its structural health. For example, the monitoring elements 50 can be actuators designed to transmit stress waves through the structure, as well as sensors designed to detect these stress waves as they propagate through the structure. It is known that the properties of the detected stress waves can then be analyzed to determine various aspects of the structure's health.

For ease of use, it is often preferable to place at least portions of the monitoring clusters 20, data bus 40, and router 30 on a flexible dielectric substrate as described above, so as to make fabrication and installation easier. Also, while the invention contemplates the use of any sensors and/or actuators as monitoring elements 50, including fiber optic sensors and the like, it is often preferable to utilize piezoelectric transducers capable of acting as both actuators (i.e., transmitting diagnostic stress waves through a structure) and sensors (detecting the transmitted stress waves). In this manner, a cluster controller 60 can direct certain of the piezoelectric transducers to propagate diagnostic stress waves through the structure, while others of the transducers detect the resulting stress waves and transmit the resulting health monitoring data back to the controller 60. When arranged on a dielectric layer as mentioned above, such networks 10 thus provide distributed networks of monitoring elements 50 that can combine the best features of both active and passive elements, all in a single easy to install dielectric layer.

It should be noted that each network 10 is capable of functioning on its own as an independent distributed structural health monitoring system, actively querying various portions of a structure that it is attached to, and/or detecting stress waves or various other quantities so as to monitor the health of different portions of the structure. All or portions of the network 10 can also be placed on a dielectric layer, making for a network 10 that is easy to manipulate and install.

It should also be noted that other embodiments of the invention exist. Most notably, the invention includes embodiments employing multiple networks 10 whose data buses 40 are each connected by a central data line 70 to a central controller 80. The central controller 80 selects appropriate networks 10 for carrying out monitoring operations, and instructs their routers 30 to carry out monitoring operations (such as actively querying the structure, or detecting stress waves within the structure) by transmitting instructions along the data line 70 and data buses 40. These routers 30 then select appropriate monitoring clusters 20 and initiate the monitoring operations by transmitting instructions to the correct cluster controllers 60 along the data bus 40. The cluster controllers 60 then direct their monitoring elements 50 as appropriate. Data is returned from the monitoring elements 50 to the cluster controllers 60, and forwarded on to the correct router 30. The routers 30 can then condition the data as necessary, perhaps by filtering out undesired frequencies, amplifying the signals, and the like. The data is then passed along the data buses 40 and data line 70 to the central controller 80 for analysis.

One of ordinary skill in the art will realize that the configuration of FIG. 1 confers many advantages. For instance, the system of FIG. 1 can employ multiple networks 10 attached to different parts of a structure, so that multiple different portions of a structure can be analyzed by the same system. Also, as the system of FIG. 1 employs a hierarchy of multiple distributed controllers (i.e., a central controller 80 directs the operation of routers 30, which in turn direct the operation of their associated cluster controllers 60), the system offers flexibility in its operation and update. That is, responsibilities for different portions of the scanning/monitoring process can be distributed among the different controllers. As one example, the central controller 80 can specify not only a scanning operation to be performed, but also more specific information such as the exact monitoring elements 50 that will be used, the scan frequency, and the sampling rate. Alternatively, the central controller 80 can merely request a scan, and allow lower components such as the routers 30 or cluster controllers 60 to specify the details. In addition, as different responsibilities can be located in different components, they can be allocated to those components that are most easily updated. For instance, if the central controller 80 is easily updated while the routers 30 are placed on a remote structure and cannot be easily accessed, much of the responsibility for monitoring can be placed with the central controller 80 so as to make updates as convenient as possible.

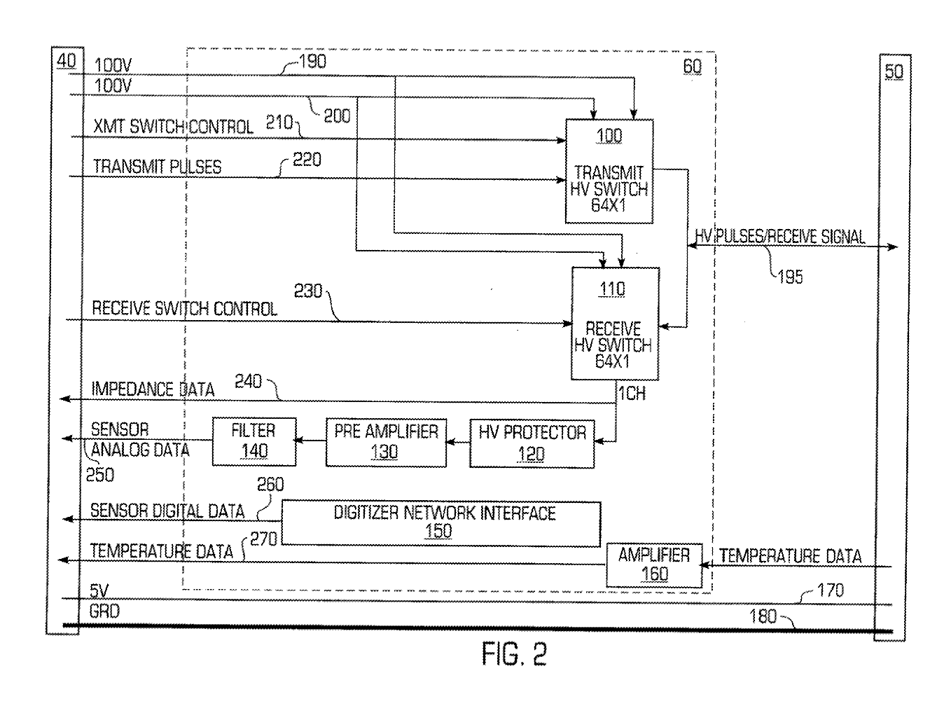

FIG. 2 illustrates an exemplary cluster controller 60 in block diagram form. As above, each cluster controller 60 controls the monitoring elements 50 of a particular monitoring cluster 20. The cluster controller 60 has a high voltage transmit switch 100 and a high voltage receive switch 110 for handling high voltage signals to the monitoring elements 50, as well as a high voltage protector 120, pre-amplifier 130, and filter 140 for conditioning data signals. Optionally, a digitizer 150 can be employed to convert the analog signals to digital data, and an amplifier 160 can be employed to separately amplify signals from temperature sensors, if the monitoring elements 50 include temperature sensors. Note that separate power lines 170 and ground lines 180 can be run between the data bus 40 and monitoring elements 50, if necessary. These lines 170, 180 can be a part of the cluster controller 60 or, as shown, they can be separate lines.

The cluster controller 60 receives control and power signals from its associated router 30 over data bus 40, and transmits data signals back to the router 30 over the same data bus 40. More specifically, when the monitoring elements 50 are actuators, or in other monitoring situations in which the monitoring elements 50 require power, the cluster controller 60 receives power from voltage lines 190, 200 to operate transmit and receive switches. The transmit switch control line 210 and transmit pulse line 220 carry signals from the cluster controller 60 (via the data bus 40) indicating which monitoring elements 50 that the high voltage transmit switch 100 is to close, and when high voltage power pulses are to be sent to those monitoring elements 50, respectively. The receive switch control line 230 indicates which monitoring elements 50 that the high voltage receive switch 110 is to close in order to receive analog signals. The received signals include, but are not limited to, impedance data over an impedance data line 240, and sensor data from those monitoring elements 50 acting as sensors. Sensor data can be sent over an analog data line 250, perhaps after filtering and amplifying by high voltage protector 120, pre-amplifier 130, and filter 140, as is known. Digital data can be transmitted over digital data line 260 after being digitized by digitizer 150.

In operation then, the cluster controller 60 transmits control signals over the transmit switch control line 210 directing the switch 100 to switch on certain monitoring elements 50. If actuation is desired, an appropriate control signal is sent over the transmit switch line 210 directing the transmit switch 100 to allow high voltage pulses over the transmit pulse line 220, to those monitoring elements 50 that have been selected. Power for these pulses is supplied by the cluster controller 60, router 30, or another source. Those monitoring elements 50 convert electrical energy into mechanical stress waves that propagate through the structure to be monitored.

When sensing is desired, such as during detection of mechanical stress waves, the router 30 transmits switch control signals over the receive switch control line 230 directing the receive switch 10 to allow data signals from certain monitoring elements 50. When the monitoring elements 50 is employed as both an actuator and a sensor, typically referred to as pulse echo mode, the high voltage transmit pulses pass through transmit high voltage switch 100 and can also pass through receive high voltage switch 110. In order to prevent these high voltage signals from damaging low voltage electronics components, a high voltage protector 120 is also employed. The received analog signals can be filtered and amplified as necessary. The conditioned signals are then passed back to the router 30 via line 250. If digital data signals are desired, the digitizer 150 can convert the conditioned analog data signals to digital signals, and pass them to the router 30 via line 260. When temperature data is desired, signals from monitoring elements 50 that are configured as temperature sensors are sent to amplifier 160 for amplification as necessary, then passed to router 30 along line 270.

Sensing can also involve previously-unprocessed data. For example, the analog voltage signal received from the monitoring elements 50 can also indicate the impedances of the elements 50. This impedance data can yield useful information, such as whether or not a particular element 50 is operational. As the impedance value of an element 50 is also typically at least partially a function of its bonding material and the electrical properties of the structure it is bonded to, the impedance of an element 50 can also potentially yield information such as the integrity of its bond with the structure.

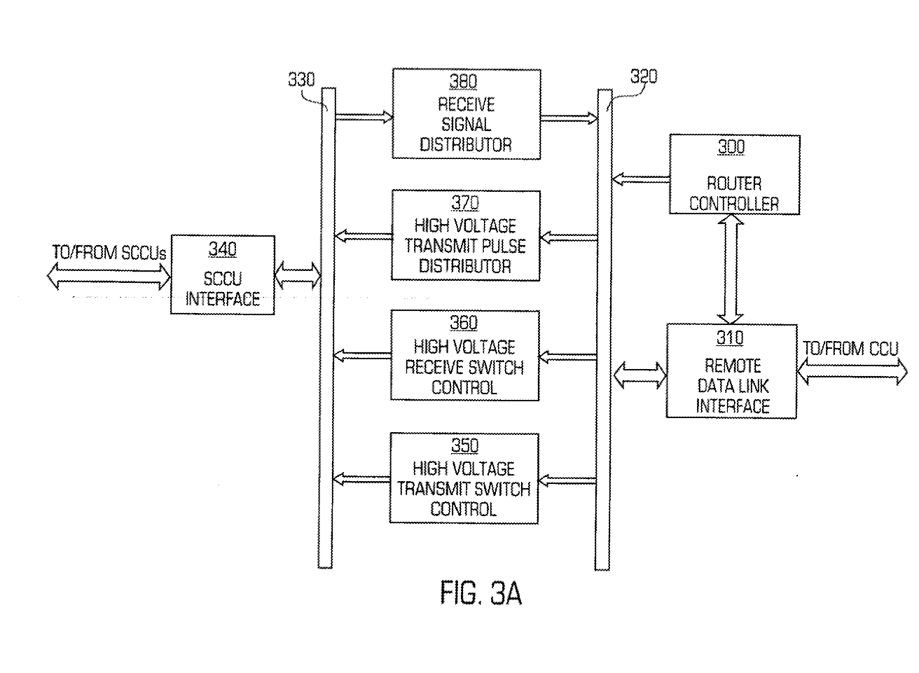

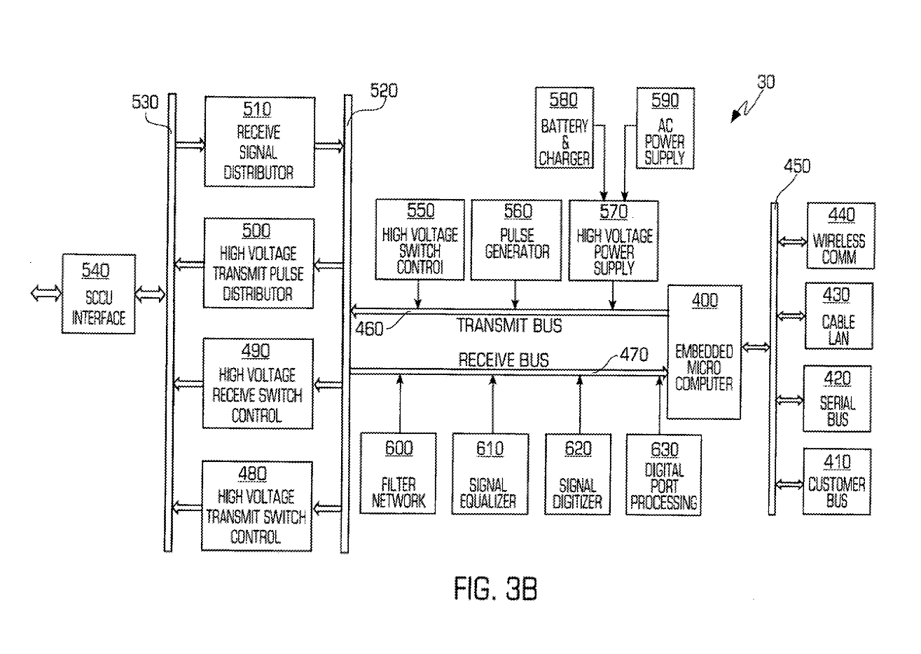

FIG. 3A illustrates further details of a first configuration of a router 30. It is often preferable for the router 30 to perform the functions of selecting the appropriate monitoring clusters 20, and directing control and power signals to those clusters 20 as appropriate. To that end, the router 30 includes a router controller 300 for controlling the operation of the router 30, an interface 310 for interfacing with the central controller 80, internal data buses 320, 330, and a cluster controller interface 340 for interfacing with the various cluster controllers 60. The router 30 also has a high voltage transmit switch controller 350 for instructing cluster controllers 60 to switch on various monitoring elements 50 (i.e., those monitoring elements identified by the router controller 300), and a high voltage receive switch controller 360 for instructing cluster controllers 60 to monitor certain monitoring elements 50 for receiving data signals. The identification of which monitoring elements 50 are to be switched to transmit power, and which are to be monitored for receiving data, can be performed by the router controller 300, in which case the router controller 300 transmits the appropriate commands identifying the monitoring elements 50 to the high voltage transmit switch controller 350 or the high voltage receive switch controller 360, respectively.

The high voltage transmit pulse distributor 370 directs high voltage pulses to the voltage lines 220 when instructed by the router controller 30. The receive signal distributor 380 receives data signals sent from the cluster controller 60 (i.e., data signals sent from the monitoring elements 50 to the receive switch 110, then along the data line 250), and directs them to the interface 310 for forwarding to the router controller 300 or the central controller 80, depending on which unit is responsible for processing gathered data.

In the embodiment of FIG. 3A, the router 30 is responsible for selecting those cluster controllers 60 and associated monitoring elements 50 that will perform monitoring operations, transmitting the appropriate power and control signals to those cluster controllers 60, and receiving any resulting data. In another embodiment, the router 30 also has additional responsibilities, and carries out tasks in addition to those just listed. FIG. 3B illustrates further details of a second configuration of a router 30. In this embodiment, the router 30 includes a router controller 400 for controlling the operation of the router 30, as well as a customer bus 410, serial bus 420, cable LAN 430, and wireless link 440 connected to the router controller 400 via the bus 450 and allowing the router controller 400 to communicate with the central controller 80 as well as other devices. The controller 400 transmits instructions to the cluster controllers 60 over the transmit bus 460, and receives data back from the cluster controllers 60 over the receive bus 470. The cluster controller interface 540, high voltage transmit switch controller 480, high voltage receive switch controller 490, high voltage transmit pulse distributor 500, and receive signal distributor 510 operate as their respective components 340-380, with some exceptions.

First, high voltage switching instructions are provided to the switch controller 490 by a dedicated switch controller 550, and transmit pulse signals for those monitoring elements 50 acting as actuators are supplied to the high voltage transmit pulse distributor 500 by the pulse generator 560. The pulse generator 560 produces any desired pulse signals, such as Sinusoidal waveforms, Gaussian waveforms, and others, using power supplied by the high voltage power supply 570. The high voltage power supply 570 is, in turn, powered by battery 580 or AC power supply 590. The battery 580 and power supply 590 can be located proximate to the network 10 or even, if they are compact and lightweight enough, on the flexible layer. Larger versions of the battery 580 and power supply 590 can also be located remotely.

Second, data signals returned from the receive signal distributor 510 are processed by dedicated components, instead of by the router controller 400 or other components. Such components can execute any processing that facilitates accurate analysis of the data signals. In the embodiment of FIG. 3B, the components include a filter network 600 for filtering undesired frequencies of the data signals (e.g., noise, etc.), and a signal equalizer 610 configured to compensate for distortion in the data signals and/or to provide a variable gain for signals received from each sensing element 50. By applying a variable gain specific to each received sensor signal, the equalizer 610 can variably amplify signals, amplifying those that may be weak, while simultaneously attenuating those that may be too strong. This allows for sensor data of more overall-uniform amplitude. This in turn increases the sensitivity and accuracy of the overall system. The components also include a signal digitizer 620 if digitization of the data signals is desired, and a digital post processor 630 for any desired post processing of the digitized data signals. The presence of such dedicated components 600-630 reduces processing burden on the controller 400 and/or other components, and provides for greater modularity and flexibility in the design of the router 30.

As described above in connection with FIG. 1, the central controller 80 typically instructs other components such as the routers 30 to perform monitoring operations on a structure, and can analyze any resulting data. Partly because the central controller 80 can take on varying responsibilities for handling various aspects of the scanning/monitoring process, the invention encompasses various configurations of the central controller 80. That is, the central controller 80 can be configured as a portable computer, a desktop computer, and a server computer, all in keeping with the invention.

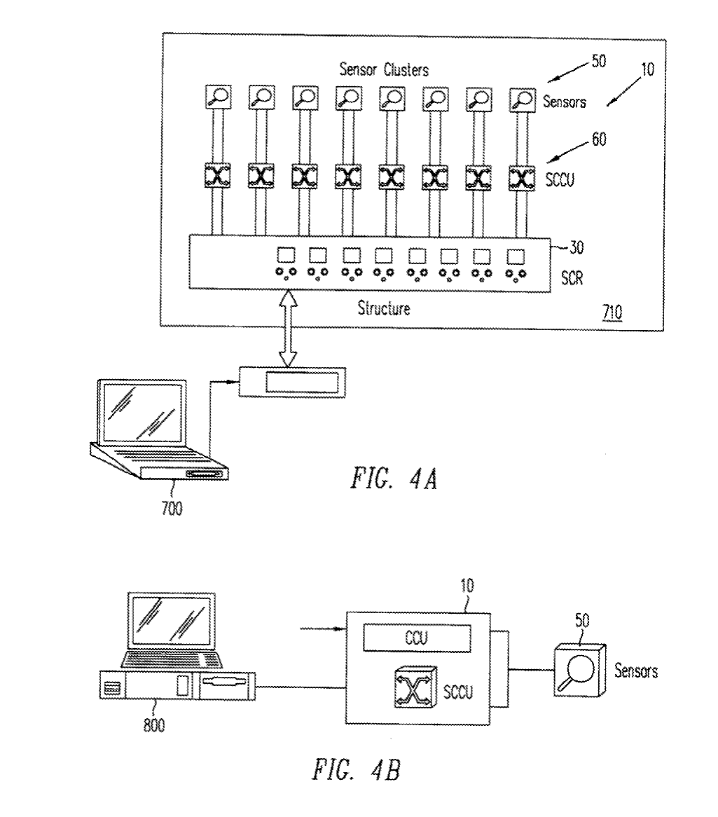

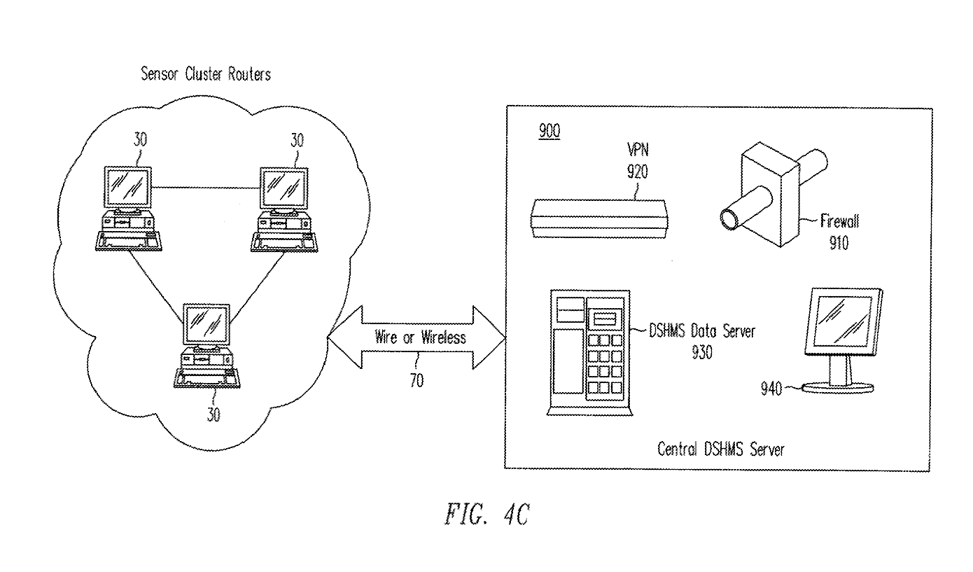

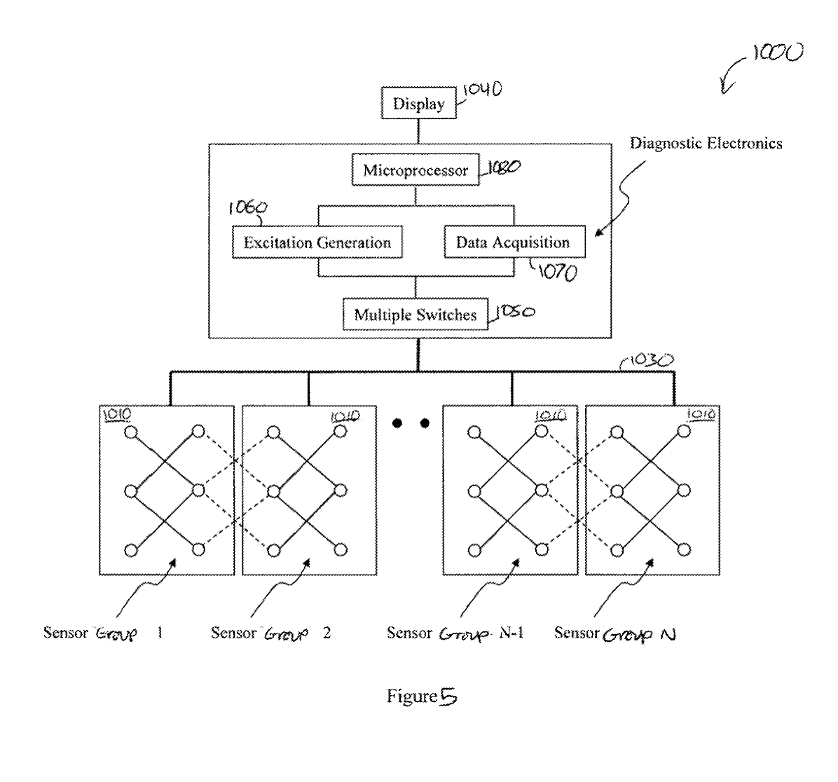

To that end, FIG. 4A illustrates a central controller 80 configured as a portable computer 700. One of ordinary skill in the art will observe that the central controller 80 of the system of FIG. 1 can be incorporated within the portable computer 700, especially in embodiments employing simpler configurations of the controller 80. For example, configuration as a portable computer 700 is often made easier when the central controller 80 delegates execution of many monitoring and/or processing operations to other components such as the routers 30. Such configurations are also made easier when, as in FIG. 4A, only a single structure 710 is monitored with only a single network 10, reducing the processing demand on the portable computer 700. Configuration of the central controller 80 as a portable computer 700 is desirable in many applications, such as when moving structures are monitored. One of ordinary skill will also realize that the central controller 80 can be incorporated within the portable computer 700, or it can be configured as one of any known add-on cards for use with a computer 700.

FIG. 4B illustrates a central controller 80 configured as a desktop computer 800. One of ordinary skill in the art will observe that the desktop configuration of FIG. 4B is desirable in embodiments not requiring portability, or in embodiments requiring greater computing resources than offered by portable computers 700, such as configurations of the controller 80 that take on more duties in the scanning/monitoring process. As with the portable computer 700 configuration above, the central controller 80 can be incorporated within the desktop computer 800, or it can be configured as an add-on card for plugging into the desktop computer 800 (e.g., a controller card that can be plugged into the PCI bus slot of computer 800).

FIG. 4C illustrates a central controller 80 configured as a server computer 900. In this configuration, the server computer 900 can be equipped not only to carry out processing in accord with the invention, but also to employ many other known resources available to current server computers 900. For instance, the server 900 can be equipped with a protective firewall 910, a VPN 920 for securing the network 10 and the resulting data, a data server 930 for carrying out processing of data and storing the results, and monitors 940 for viewing the status of the network 10 and the resulting data. As is known, the server 900 is capable of interfacing directly with data link 70, which can be a wire or a wireless connection. Communication with the routers 30 is performed as described above.

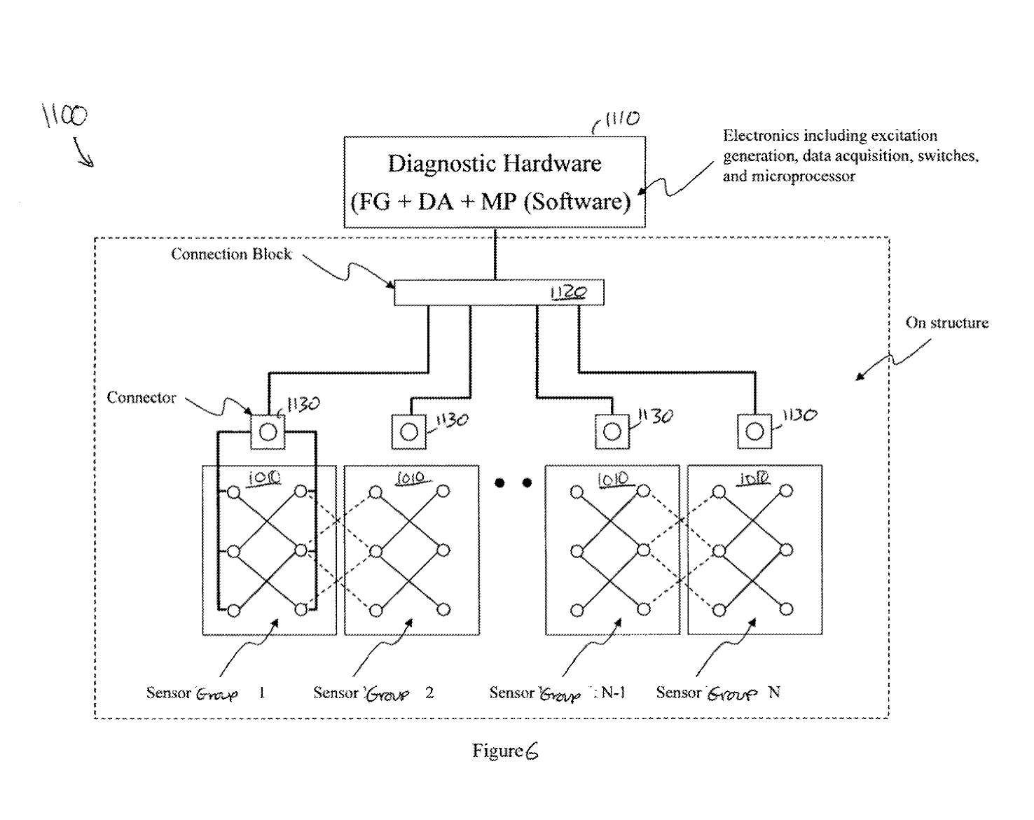

The invention also encompasses various other hardware configurations besides those shown in FIGS. 1-4. As one example, FIG. 5 illustrates a structural health monitoring system 1000 that includes multiple sensor groups 1010, diagnostic electronics 1020 connected to the sensor groups 1010 by electrical connectors 1030, and a display 1040. The diagnostic electronics 1020 include a switch bank 1050, excitation generation module 1060, data acquisition module 1070, and microprocessor 1080. The switch bank 1050 contains switches for selecting individual sensor groups 1010, and specified sensors within each group 1010. The connectors 1030 are not a single wire as shown, but are instead a set of conductors connected between each switch and a single sensor. In this configuration, the diagnostic electronics 1020 largely performs the functions of the central controller 80 and cluster controllers 60. Thus, in operation, the microprocessor 1080 directs the excitation generation module 1060 to generate high voltage diagnostic signals that the switches 1050 direct to specified sensors of a sensor group 1010. Other sensors detect the stress waves generated from the diagnostic signals, and transmit corresponding voltage signals that are directed by the switches 1050 to data acquisition module 1070 and microprocessor 1080 for conditioning and analysis. The sensors of each sensor group can be placed on a single flexible substrate, as shown. Alternatively, the flexible substrates can be omitted.

In the configuration of FIG. 5, the functionality of the cluster controllers 60 and central controller 80 is centralized in a single diagnostic electronics module 1020, rather than being distributed to multiple units. Thus, a single diagnostic module 1020 controls the operation of multiple different sensor groups 1010. This allows for centralized control of multiple groups of sensors. Such a configuration has many advantages, including allowing multiple different sensor groups 1010 to be controlled by one set of hardware. In this manner, a single signal generator can be used for many different sets of sensor networks, and signals from many different networks can be received/processed/analyzed by a single data acquisition module.

FIG. 6 illustrates a further exemplary embodiment of the invention. Like the system 1000 of FIG. 5, the system 1100 of FIG. 6 has a single diagnostic hardware unit 1110 that can contain the same components, and possess the same functionality, as diagnostic electronics 1020. The system 1100 also includes a connection block 1120 electrically connected to a set of connectors 1130, each connected to the sensors of a sensor group 1010. The connection block 1120 is configured for connection to the output of switch block 1050, so that high voltage diagnostic signals and monitoring signals from the sensors are routed to the switch block 1050 via the connection block 1120 and connectors 1130. In this embodiment, the connection block 1120 and connectors 1130 provide an electrical connection between each switch of the switch block 1050 and its corresponding sensor. In other words, the configuration of FIG. 6 can be thought of as the configuration of FIG. 5, except with the electrical connectors 1030 replaced with the connection block 1120 and connectors 1130. If the connection block 1120 and connectors 1130 are made sufficiently small, lightweight, and portable, each of the components shown within the dotted line of FIG. 6 can be placed on the structure to be monitored, so that monitoring of the structure can be accomplished by simply connecting the hardware unit 1110 to a single connector, i.e. the interface to connection block 1120. This configuration thus allows for monitoring of multiple different areas of a structure by simply connecting the hardware unit 1110 to a single interface.

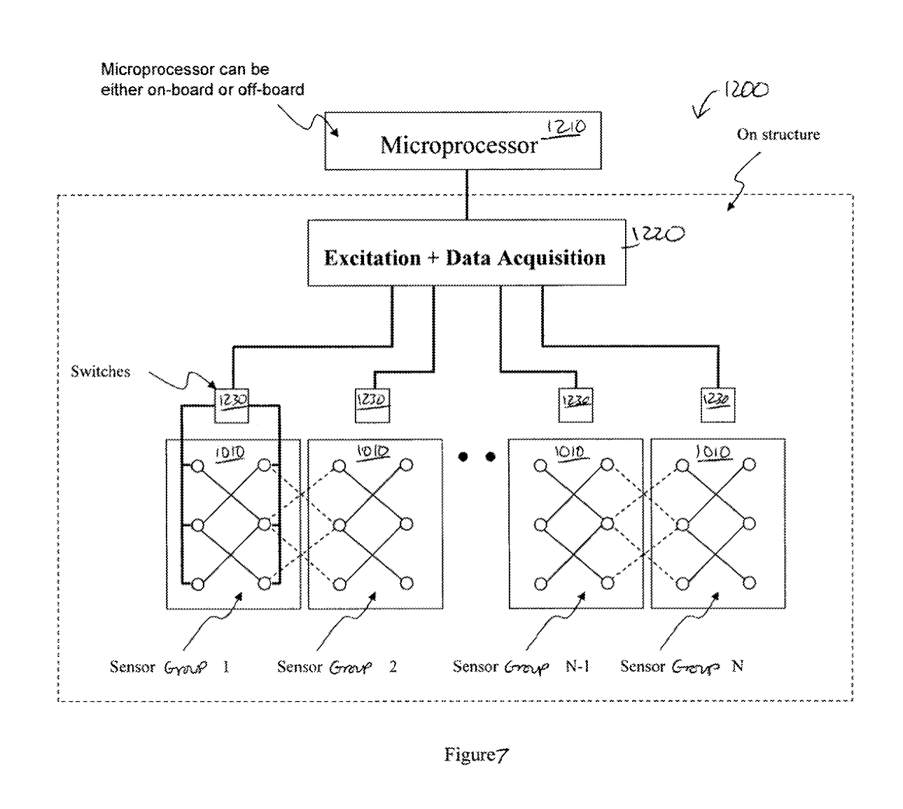

It is also possible to effectively divide the hardware unit 1110 into different units, and place one or more of those units on the structure. In this manner, some units can be fixed to the structure, while others can be remote from the structure and/or removable. As one example, in FIG. 7, structural health monitoring system 1200 has a microprocessor 1210 separate from, but in communication with, an excitation and data acquisition unit 1220. The excitation and data acquisition unit 1220 is, in turn, in communication with switches 1230 and sensor groups 1010. Here, the diagnostic electronics 1020 of FIG. 5 can be thought of conceptually as being divided into a separate microprocessor unit 1210 and excitation and data acquisition unit 1220, so that the unit 1220 includes excitation generation module 1060, data acquisition module 1070, and some of the switches of switch bank 1050. The unit 1220 thus switches from among sensor groups 1010 to select desired groups, with the corresponding switches 1230 switching various sensors from those selected sensor groups 1010 on/off.

In the configuration of FIG. 7, the excitation and data acquisition unit 1220, switches 1230, and sensor groups 1010 are each affixed to the structure being monitored. The microprocessor unit 1210 (which can be basically the microprocessor 1080 and display 1040 of FIG. 5) can be a separate unit configured for connection to the on-structure units by an interface to unit 1220. This allows for a smaller and more portable hardware unit 1210.

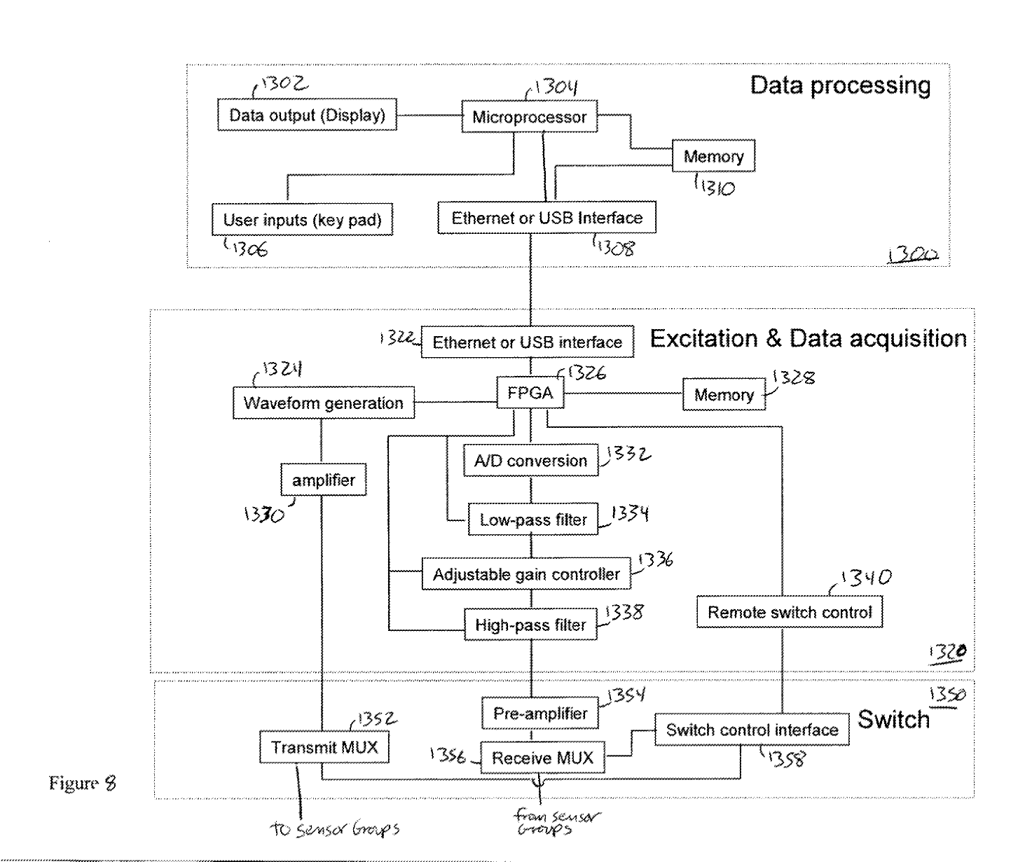

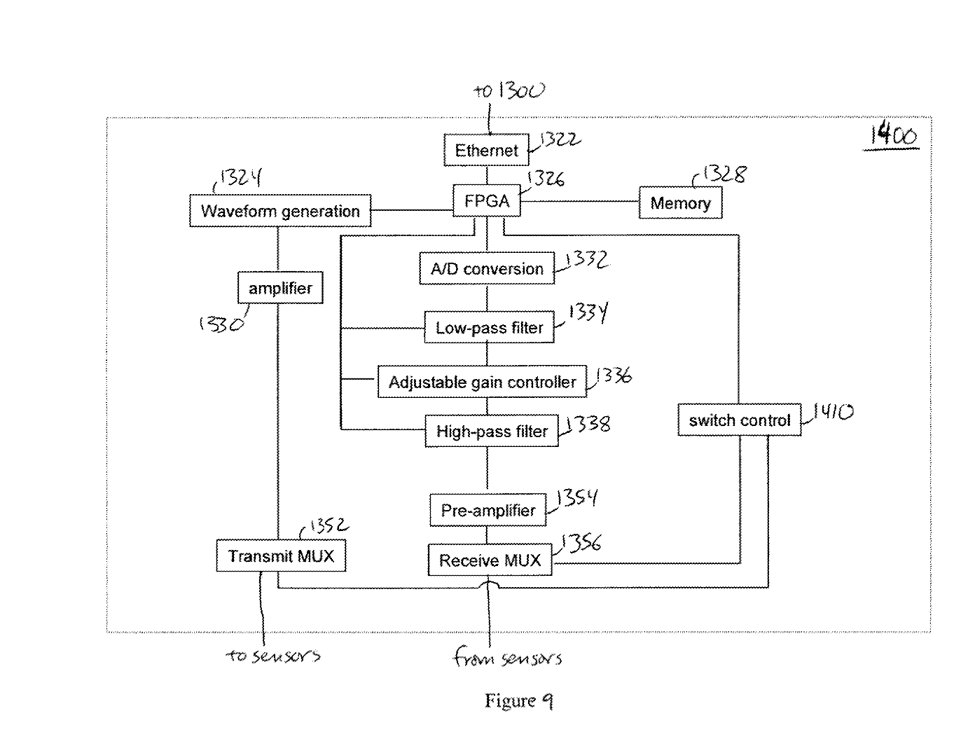

One of ordinary skill in the art will realize that certain embodiments of the invention involve distributing various functions and components of the diagnostic electronics unit 1020 among different units, and locating some or all of these units on or remote from the structure as desired. To that end, FIGS. 8-10 illustrate various configurations of the functions and components of the diagnostic electronics unit 1020, and also illustrate further detail of the hardware blocks used.

FIG. 8 illustrates one configuration in which the functionalities of unit 1020 are divided amongst a separate data processing unit 1300, excitation and data acquisition unit 1310, and switch unit 1320. The data processing unit 1300, excitation and data acquisition unit 1310, and switch unit 1320 can each be located either on the structure or remote. For example, if the excitation and data acquisition unit 1310, and switch unit 1320 are both affixed to the structure, the system resembles that of FIG. 7.

The data processing unit 1300 includes a display 1302 or other data output device, a microprocessor 1304, user input 1306 such as a key pad or other device, an interface 1308 such as an Ethernet or USB interface, and a memory 1310. The memory 1310 can store waveforms for diagnostic signals, and can also store sensor signal data. The microprocessor 1304 can initiate diagnostic testing of the structure (perhaps automatically, or upon receiving instructions from input 1306) by retrieving waveforms from memory 1310 and transmitting them to excitation and data acquisition unit 1320 across interface 1308. Sensor signal data are also received through interface 1308, stored in memory 1310, and/or processed by microprocessor 1304 to determine the health of the structure. Results are sent to the output 1302 for display.

The excitation and data acquisition unit 1320 includes an interface 1322 for connection to interface 1308, waveform generator 1324, field programmable gate array (FPGA) 1326, memory 1328, and amplifier 1330. Unit 1326 is shown here as an FPGA, but can be any suitable processor. Upon receiving either a waveform or an instruction across interface 1322, FPGA 1326 instructs waveform generator 1324 to generate a high voltage diagnostic signal for initiating a stress wave in the structure. If the waveform is not sent from processor 1304 (i.e., if the processor 1304 only sends an instruction to generate diagnostic signals, rather than a waveform), the FPGA retrieves the appropriate waveform from memory 1328 and sends it to waveform generator 1324. The generator 1324 generates the corresponding electrical waveform, which is then amplified by amplifier 1330 and sent to switch unit 1350. The FPGA 1326 also directs a remote switch control block 1340 to transmit a switch signal to switch block 1350, directing the switch block 1350 to direct the electrical waveform to specified sensors within specified sensor groups 1010.

The excitation and data acquisition unit 1320 also includes an analog to digital (A/D) conversion block 1332, a low pass filter 1334, adjustable gain controller 1336, and high pass filter 1338. When signals are received from the sensors, switch block 1350 sends them to the high pass filter 1338 which filters out undesired low frequency signals such as signals with frequencies below a preferred lower bound (e.g., less than about 50 kHz, when the frequency of diagnostic signals is approximately 150 kHz), and passes the signals to the adjustable gain controller 1336. The controller 1336 adjusts the gain according to gain values stored in memory 1328 and retrieved by FPGA 1326, so that the gain of each signal is controlled on a sensor-by-sensor basis. This compensates for signal amplitude variations due to sensor variations, differing signal paths to different sensors, and the like. The gains can be determined prior to performing structural diagnostics (perhaps experimentally, once the sensors and hardware are affixed to the structure), and stored in memory 1328. The controller 1336 transmits its output to low pass filter 1334, which filters out noise and sends its output to A/D converter 1332 for conversion to digital signals. The digitized and conditioned sensor signals are then sent to FPGA 1326, which forwards them to data processing block 1300 for processing and/or storage.

The switch block 1350 includes a transmit multiplexer (MUX) 1352, pre-amplifier 1354, receive MUX 1356, and switch control interface 1358. The switch control interface 1358 receives instructions from switch control 1340 directing it to switch on/off certain switches (i.e., open/close paths to specified sensors of specified sensor groups 1010), and directs the transmit MUX 1352 and receive MUX 1356 to open/close signal paths to certain sensors. Diagnostic signals are then sent from amplifier 1330 through transmit MUX 1352 to these selected sensors, while signals from other sensors are received at receive MUX 1356. These received signals are sent to pre-amplifier 1354 for amplification to amplitudes suitable for conditioning and processing, and then sent on to high pass filter 1338, where they are conditioned/processed as above.

In operation then, the microprocessor 1304 selects sensors for transmitting diagnostic signals, and sensors for receiving the resultant stress waves. The selection can be automatic, or performed according to user direction from input 1306. Information on the selected sensors is then sent to the FPGA 1326. The waveforms for the diagnostic signals can be either retrieved from memory 1310 and sent to the FPGA 1326, or retrieved by the FPGA from its own memory 1328. The FPGA 1326 then sends the waveform data to waveform generator 1324, beginning the generation of diagnostic waveforms. The FPGA 1326 also sends the sensor information to switch control 1340, instructing the switch controller 1340 to turn on (i.e., close) those switches corresponding to the sensors that are to transmit the diagnostic waveforms, and those sensors that are to receive the corresponding stress waves. The number and identity of these sensors is determined by the analysis method desired, and one of ordinary skill will observe that the switch controller 1340 can turn on/off any sensors as desired. The switch control interface 1358 directs the transmit MUX 1352 and receive MUX 1356 to close/open switches according to instructions from the switch control 1340, so that the diagnostic signals are sent only to those sensors selected by microprocessor 1304, and corresponding stress waves are detected at only those sensors selected by microprocessor 1304. In this manner, interrogation can be carried out exclusively by those sensors selected for the task, with detection also performed exclusively by pre-selected sensors. This allows any single system of the invention to perform a wide variety of querying/interrogation techniques.

It is also possible to divide the functions of unit 1020 between two components, instead of the three shown in FIG. 8. For example, FIG. 9 illustrates an embodiment in which the excitation and data acquisition unit 1320 and switch unit 1350 are combined into a single unit 1400. The unit includes blocks 1322-1338 and 1352-1356 each configured as above. However, as the switch unit 1350 and excitation and data acquisition unit 1320 are integrated together rather than maintained as separate units, there is no need for a separate switch control 1340 and switch control interface 1358. Instead, a single switch control block 1410 is employed, which both receives switching information from FPGA 1326 and directs the switches of MUXes 1352, 1356 accordingly. In this configuration, only two distinct units are required, instead of the three units shown in FIG. 8.

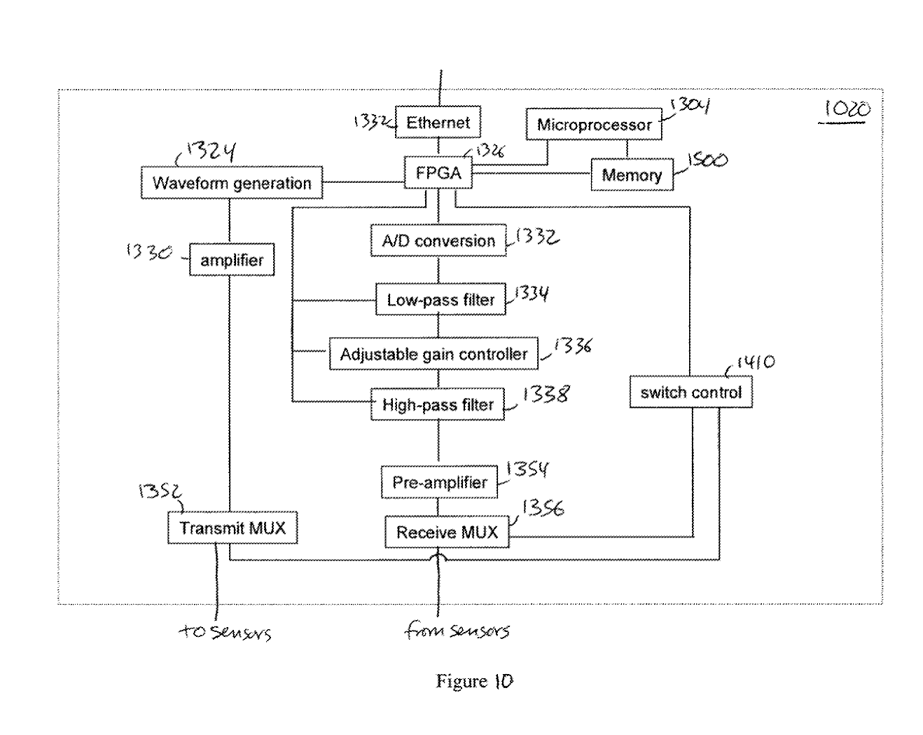

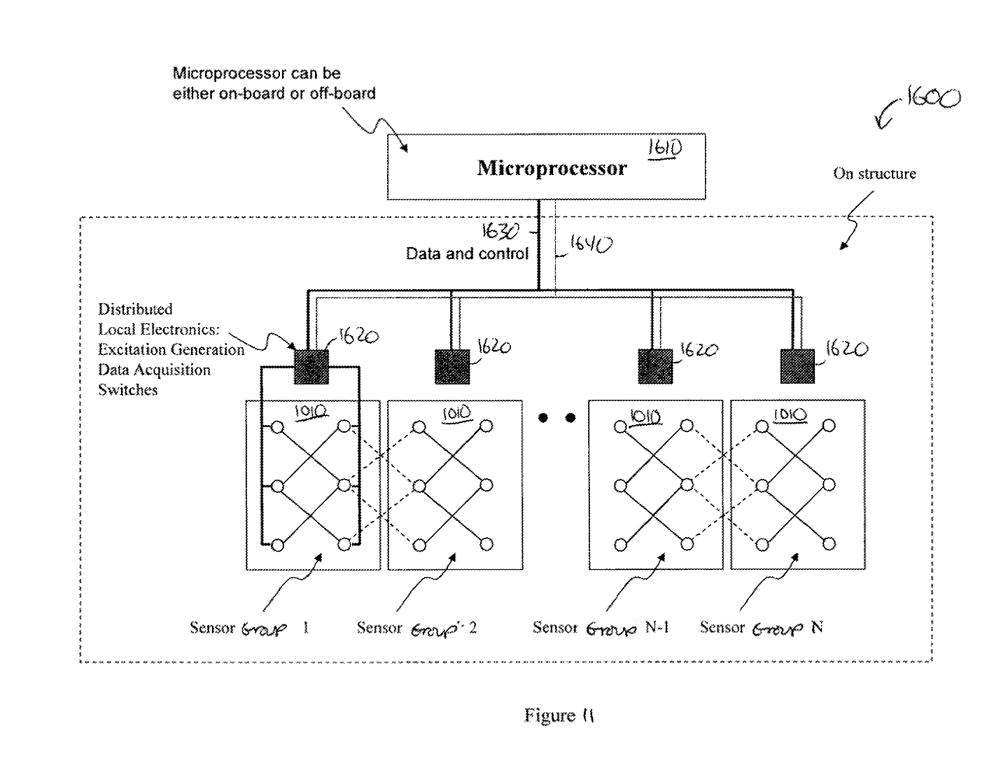

The unit 1020 can also be maintained as a single integrated unit, such as that shown in FIG. 5. FIG. 10 illustrates further details of such a unit. Here, diagnostic module 1020 is largely an integration of the excitation with the data acquisition unit 1320 and switch unit 1350, along with the microprocessor 1304 of data processing unit 1300. Module 1020 as shown here can also be thought of as the system of FIG. 9, with the addition of microprocessor 1304. The module 1020 includes blocks 1304, 1322-1326, 1330-1338, 1352-1356, and 1410 each configured as above. The memory modules 1310, 1328 are integrated into a single memory 1500 accessible by both the microprocessor 1304 and FPGA 1326. The memory 1500 can perform the same functions as both memory 1310 and memory 1328, storing waveforms and sensor data, along with any other information as desired. One or more interfaces 1322 connect to I/O devices such as a display or key pad. If multiple interfaces 1322 (not shown) are employed, one or more can be connected to microprocessor 1304 as desired.

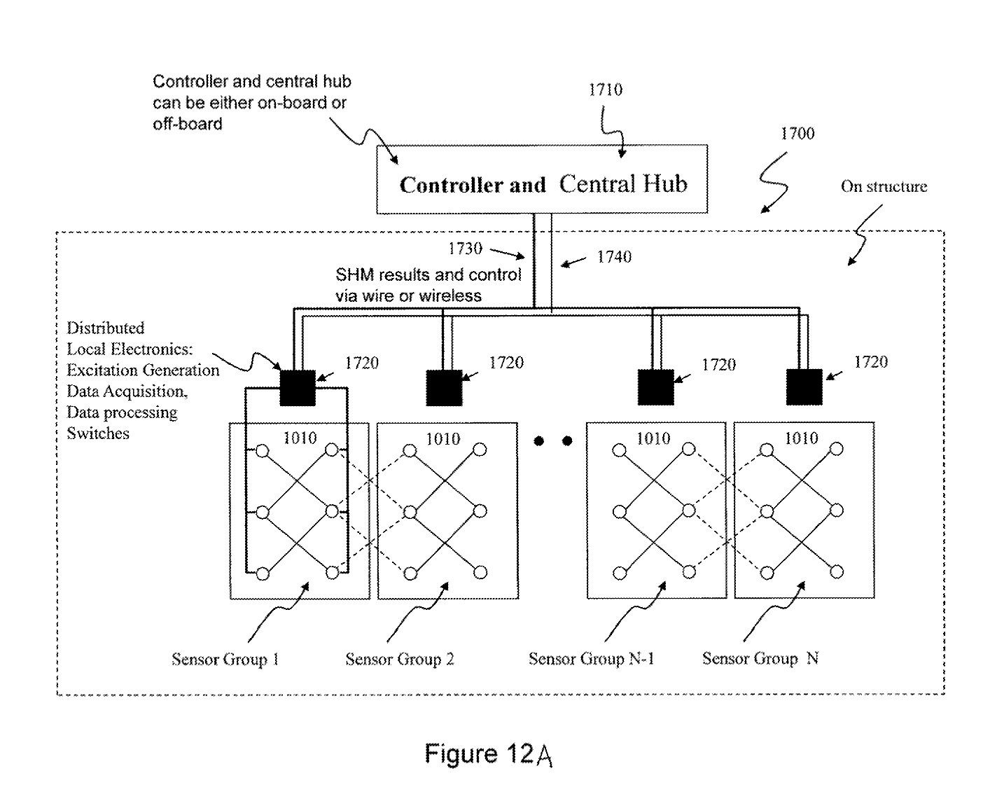

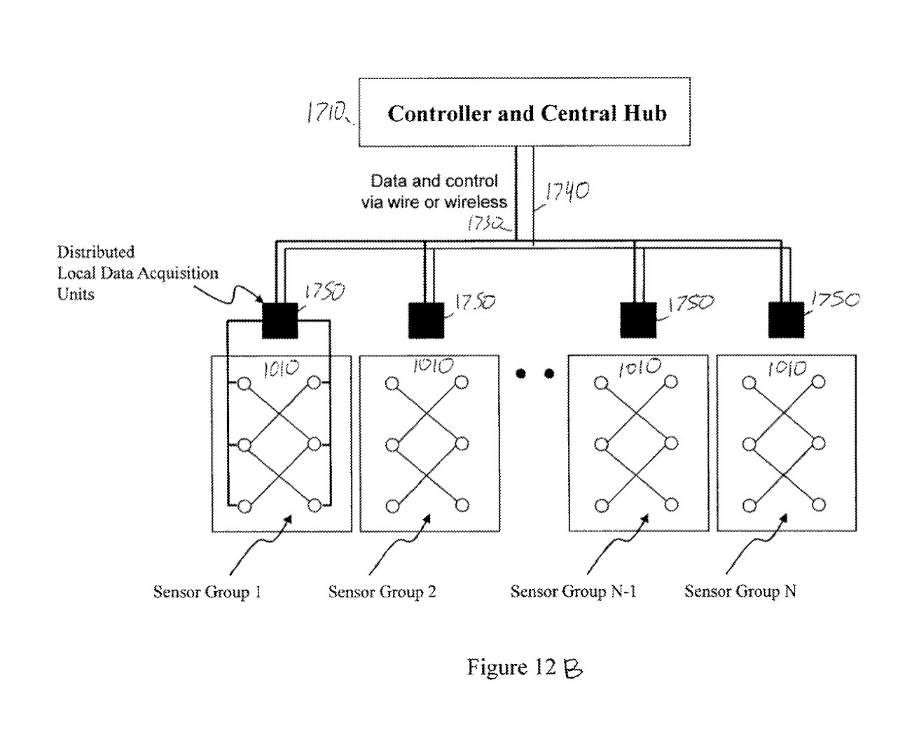

Rather than being integrated into a single module, the components and functionality of unit 1020 can also be distributed among multiple local controllers each controlling a single sensor group 1010. In some applications, it is preferable to place each of these local controllers closer to its corresponding sensor group 1010. This configuration thus resembles that of FIG. 1, except that the central controller is connected to its local controllers by wires or other one-to-one connections, rather than the bus structure 40, 70. FIGS. 11-12 illustrate two such configurations.

In FIG. 11, the system 1600 includes a central microprocessor 1610 controlling multiple local controllers 1620, each of which control one sensor group 1010. Data lines 1630 and control lines 1640 connect microprocessor 1610 to each local controller 1620. That is, lines 1630, 1640 are not unitary lines as shown, but are instead separate connections between the microprocessor 1610 and each local controller 1620.

In this configuration, each local controller 1620 includes signal generation, data acquisition, and switching functionality, and can thus be configured as unit 1400 of FIG. 9, with interface 1322 connecting to central microprocessor 1610 via one data line 1630 and one control line 1640, instead of connecting to data processing unit 1300. In this configuration, the central controller 1610 transmits switching information (i.e., data specifying which sensors are to transmit diagnostic signals, and which sensors are to detect resultant stress waves) and other commands along corresponding control line 1640 to FPGA 1326, while sensor data (i.e., signals corresponding to stress waves received at selected sensors) is transmitted to microprocessor 1610 along corresponding data line 1630.

In the configuration of FIG. 11, microprocessor 1610 handles both control of each local controller 1620 and processing of any resultant data, i.e. sensor signals. That is, each local controller 1620 is responsible for signal generation and data gathering, but not data processing. However, the invention also includes configurations in which the local controllers are responsible for data processing as well. FIG. 12A illustrates one example of the latter configuration. Here, system 1700 includes a controller and central hub 1710 connected to a number of local controllers 1720, each of which control a sensor group 1010. Results line 1730 and control line 1740 connect controller and central hub 1710 to each local controller 1720. Here, each local controller 1720 includes signal generation, data acquisition, switching, and data processing functionality, and can thus be configured as unit 1020 of FIG. 10, with interface 1322 connecting to controller and central hub 1710 via one results line 1730 and one control line 1740. In this configuration, the controller and central hub 1710 can transmit switching information and other commands along corresponding control line 1740 to FPGA 1326 of each local controller 1720. The local controllers 1720 then generate and transmit diagnostic signals, collect, condition, and process the resulting sensor data, and send the results back to controller and central hub 1710 along their results line 1730. Notably, only the results of such structure diagnostics are transmitted along results line 1730, not the sensor data. Controller and central hub 1710 thus needs not include a central microprocessor 1610, as the responsibilities of the microprocessor 1610 can instead be assumed by the microprocessor 1304 of each local controller 1720.

The invention contemplates setup and use of the above-described systems, and others, in any suitable manner. In many applications, the sensors of each sensor network 1010 will be prefabricated on a flexible substrate for ease of installation (as shown in many of the above figures). The desired number of sensor networks 1010 can then be installed on the structure, along with any of the other above-described components that users wish to apply on the structure. As above, many components may be placed on the structure or located remotely. The invention contemplates embodiments in which any one or more of the above-described components can be affixed to the structure or located off the structure as desired. For example, in FIG. 6, the sensing elements (i.e., each sensor group), connectors 1130, and connection block 1120 are on the structure, while diagnostic hardware 1110 is not. In FIG. 7, the microprocessor 1210 is located off structure, while the remaining components are on the structure. In FIG. 12A, the controller and central hub 1710 can be located either on or off the structure.

The invention also includes configurations with the capability for both active (excitation generation, i.e. production and detection of diagnostic/interrogating signals) and passive (detecting signals in the structure without generating any) monitoring of a structure, as well as only active, or only passive. That is, embodiments include systems that can actively query a structure, can passively detect stress waves that are generated by impacts or the like rather than being generated by the system, or both. FIG. 12B illustrates an exemplary system configured only for passive monitoring of a structure, rather than active signal generation. The system of FIG. 12B is similar to the system of FIG. 12A, except that instead of local controllers 1720, the system employs local data acquisition units 1750. The system employs only those components involved in passive structural monitoring, and as such does not contain any of the above-described components responsible for signal generation. Thus, for example, neither the controller and central hub 1710 nor the local data acquisition units 1750 include a waveform generation module 1324, amplifier 1330, transmit MUX 1352, or the like. In operation, the local data acquisition units 1750 only acquire data, i.e. they receive signals from their associated sensing elements, condition, process, and/or analyze them, and transmit data/results to controller and central hub 1710 for transmission or analysis. The units 1710, 1750 do not possess the capability to either generate or transmit diagnostic/interrogating signals to any sensing element.

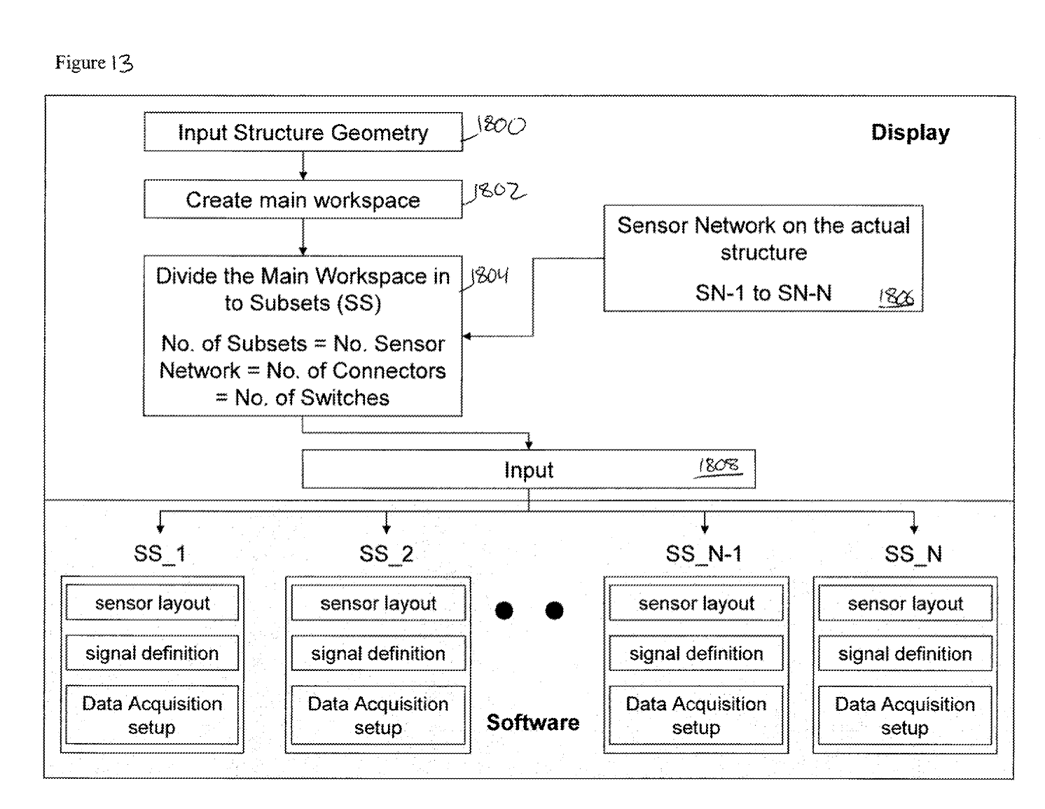

While the invention encompasses any method of diagnosing a structure, and any method for processing sensor data, various applications may require information on the structure and system to carry out their analyses. To facilitate diagnosis of the structure, any desired information can be input to the system and stored in memory prior to structural diagnosis. FIG. 13 conceptually illustrates one example of the input and storage of such information, in which desired information is input via the display or other user interface of one of the above-described systems, and stored in its memory. The “display” block of FIG. 13 can be any of the display/user input devices described previously, or any suitable device for entering information for storage in memory. Similarly, the “software” block of FIG. 13 can be any software for carrying out structural health monitoring, resident on/in any memory or processor.

With reference to FIG. 13, users can first enter relevant structure geometry (step 1800), such as the shape and material of areas of interest on the structure. A workspace can then be designated (step 1802), i.e. the area(s) of the structure that are to be diagnosed. The workspace is then divided into subsets SS, where each subset SS corresponds to an area covered by a sensor network 1010 (steps 1804-1806). Each subset SS is defined according to the positions of each of its sensors. Additional information, such as the signal definition, or waveforms of the signals to be used, is input as desired, whereupon the data are stored in memory for use by the structural health monitoring software (step 1808). In this manner, the software of the invention can store a set of data for each subset SS_x that includes sensor layout data (the position of each sensor in that sensor network), signal definitions (e.g., the amplitude and frequency of a diagnostic, or actuation, signal for each actuator-sensor path), and data acquisition setup information (e.g., information used by the system to perform data acquisition, such as sample rate, sample points, and amplifier gain for signals from each sensor).

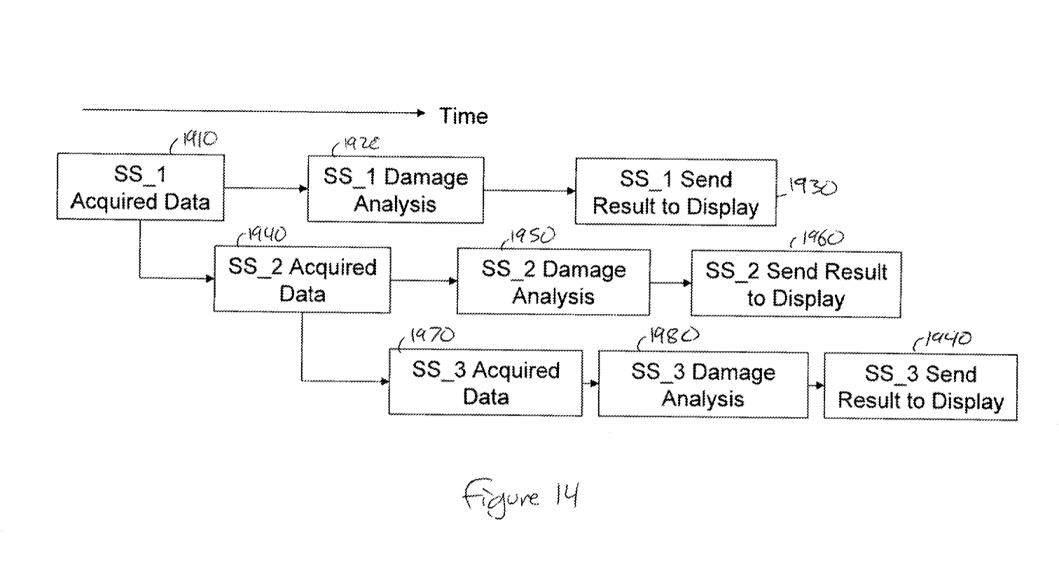

The system can then carry out diagnostic tests at any sensor network 1010, using this stored data as well as the resultant sensor signals to determine the health of the structure in the area covered by that sensor network 1010. In one embodiment, the systems of the invention can diagnose the structure on a subset-by-subset basis, carrying out an analysis of each subset SS in order. That is, systems of the invention can analyze their structures one sensor network 1010 at a time, in sequential manner. FIG. 14 illustrates one such analysis process. Here, systems of the invention interrogate their structure using each of their sensor networks 1010 individually, in order. In this manner, the system selects a first sensor network 1010, transmits diagnostic signals through selected sensors of this first network 1010 and receives corresponding stress waves at other selected sensors of this first network 1010 or another sensor network. The system then selects a second sensor network 1010, transmits the same or different diagnostic signals through selected sensors of this second network, and detects corresponding tress waves at other selected sensors of this second network or another. This process is repeated for different sensor networks 1010, as desired.

To prevent crosstalk, interrogation with one sensor network 1010 is not begun until interrogation with the previous network 1010 has completed. However, to analyze a structure more quickly, data from each network 1010 can be analyzed while the next network carries out its interrogation. FIG. 14 further illustrates this process, conceptually showing the sequence of tasks carried out, with the arrow representing the progression of time. Here, the system analyzes the first subset SS_1 (i.e., the first of its sensor networks 1010) by interrogating the structure using the first sensor network 1010 and detecting the resulting data (step 1910). That is, querying signals are sent through sensors of the first sensor network 1010, stress waves are detected at other sensors of the first sensor network 1010, and the resultant data signals are collected and conditioned. The data are then sent to the microprocessor for analysis, where they are analyzed (step 1920) to determine the health of the structure at the area covered by this first sensor network 1010. The results of this analysis are then sent to the system's display (step 1930).

Once step 1910 is complete, the system then begins analysis of the second subset SS_2. Thus, after step 1910 is finished and any stress waves generated in step 1910 have dissipated to the point where they will not interfere with analysis of SS_2, the second sensor network 1010 is interrogated and its data are acquired (step 1940). The data are analyzed (step 1950) and results are sent to the display (step 1960). This process repeats for successive subsets, as shown for SS_3 with steps 1970-1990.

It can be seen that, even though the data acquisition steps 1910, 1940, 1970 are performed in series, with successive data acquisition steps occurring only after previous data acquisition steps have been completed, the corresponding analysis steps 1920, 1950, 1980 and display steps 1930, 1960, 1990 are carried out in parallel. Thus, the system's processor may analyze successive sets of data, and/or display corresponding results, at the same time.

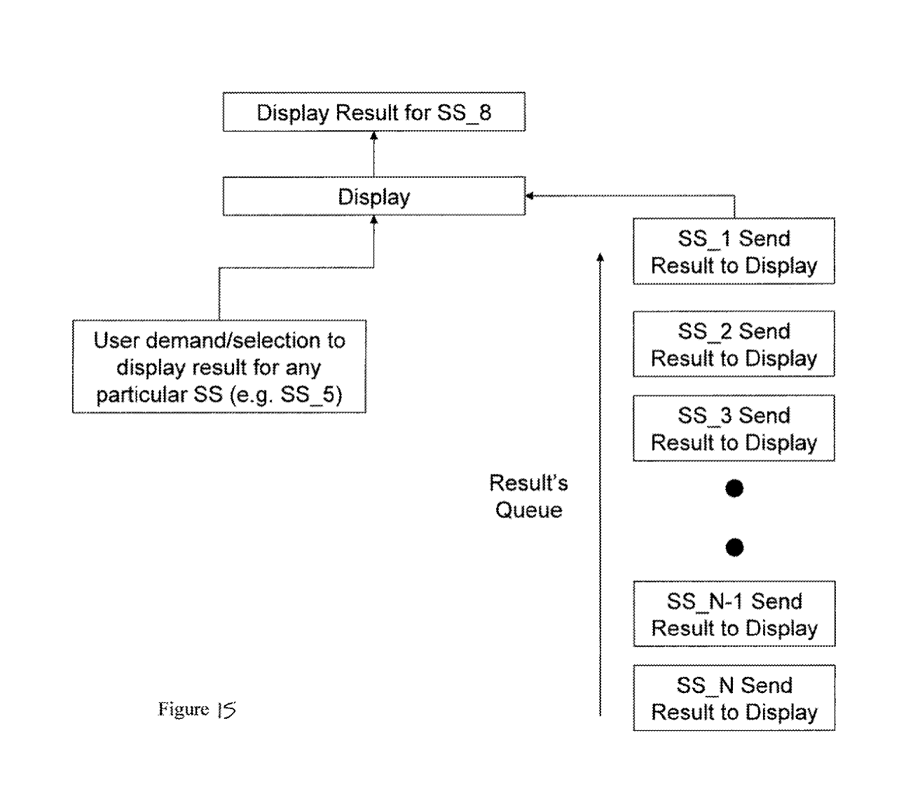

The invention also encompasses configurations in which the above-described processors and memories establish a queue for both storage and analysis of collected data, and for display of results. Thus, acquired data from successive subsets SS can be queued according to subset number, and analyzed in order. Similarly, analysis results can be stored in a queue for successive display. An example of the latter is shown in FIG. 15. Here, analysis results are queued in order of subset number, so that they can be displayed in order, or displayed according to user input.

It is also noted that, while various components are described as “high-voltage” components, various embodiments contemplate corresponding components not considered “high-voltage” by one of ordinary skill in the art. For example, signals such as actuation/diagnostic signals need not necessarily be limited to high voltages, and the invention contemplates use of any suitable voltages for generating diagnostic signals of any useful amplitude. Similarly, components need not be limited to sending, receiving, generating, analyzing, filtering, or otherwise processing/handling high-voltage signals. Rather, the components of the invention can be configured for any suitable signal amplitudes.

The foregoing description, for purposes of explanation, used specific nomenclature to provide a thorough understanding of the invention. However, it will be apparent to one skilled in the art that the specific details are not required in order to practice the invention. In other instances, well known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed. Many modifications and variations are possible in view of the above teachings. For example, the networks 10 of the invention can be implemented wholly, or partly, on flexible dielectric substrates. They can also be affixed directly to a structure, instead of employing such a substrate. Also, the central controllers of the invention, in those embodiments that employ them, can be portable computers, desktop computers, or server computers. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A structural health monitoring system, comprising:
a plurality of sensor networks, each sensor network having a plurality of sensing elements; and
a diagnostic unit, comprising:
a signal generation module configured to generate first electrical signals for generating stress waves in a structure; and
a data acquisition module configured to receive second electrical signals generated by the sensing elements, the second electrical signals corresponding to the generated stress waves;
wherein the diagnostic unit is programmed to select ones of the sensor networks so as to designate selected sensor networks and, for each selected sensor network, to select a first set of sensing elements and a second set of sensing elements, to direct the first electrical signals exclusively to the first set of sensing elements, and to receive the second electrical signals exclusively from the second set of sensing elements.

2. The structural health monitoring system of claim 1 further comprising a plurality of flexible substrates each associated with a different one of the sensor networks, the sensing elements of each sensor network affixed to the associated flexible substrate.

3. The structural health monitoring system of claim 1 wherein the diagnostic unit further comprises an electrical interface electrically connecting the signal generation module and the data acquisition module to the sensing elements of each of the sensor networks.

4. The structural health monitoring system of claim 1 wherein the diagnostic unit further comprises a processor and a memory, the memory storing at least one waveform of the first electrical signals, and the processor configured to direct the signal generation module to generate the first electrical signals having the stored waveform.

5. The structural health monitoring system of claim 4, wherein the sensor networks, the signal generation module, and the data acquisition module are each configured for attachment to the structure.

6. The structural health monitoring system of claim 5, wherein the memory and the processor are each configured for attachment to the structure.

7. The structural health monitoring system of claim 1, wherein the diagnostic unit is further programmed to:
(a) select one of the sensor networks;
(b) select the first set of sensing elements from the sensing elements of the selected sensor network;
(c) select second sensing elements;
(d) transmit the first electrical signals only to the first set of sensing elements, so as to generate the stress waves in the structure;
(e) receive the second electrical signals from the second sensing elements;
(f) analyze data corresponding to the received monitoring signals, so as to determine a health of an area of the structure corresponding to the selected sensor network; and
(g) after (e), select a different one of the sensor networks, and repeat (b)-(f) in order.

8. The structural health monitoring system of claim 7 wherein (f) further comprises entering results of the analyzing into a queue.

9. The structural health monitoring system of claim 8, wherein the diagnostic unit is further programmed to retrieve the results from the queue, and to display the retrieved results.

10. The structural health monitoring system of claim 7 wherein (c) further comprises selecting the second sensing elements from the selected sensor network.

11. A structural health monitoring system, comprising:
a plurality of sets of sensing elements and a plurality of flexible substrates, each set of sensing elements affixed to a different one of the flexible substrates;
a signal generation module configured to generate first electrical signals for generating stress waves in a structure;
a data acquisition module configured to receive second electrical signals generated by the sensing elements, the second electrical signals corresponding to the generated stress waves;
a set of switches in electrical communication with the signal generation module, the data acquisition module, and each set of sensing elements, each switch of the set of switches individually operable to place one sensing element in electrical communication with at least one of the signal generation module and the data acquisition module; and
a processing unit having a computer-readable memory storing instructions, the instructions comprising:
a first set of instructions to select ones of the sets of sensing elements, so as to designate selected sensing elements;
a second set of instructions to select a first sensor group from the selected sensing elements, and to select a second sensor group;
a third set of instructions to direct the set of switches to place only the sensing elements of the first sensor group in electrical communication with the signal generation module, so as to direct the first electrical signals to the sensing elements of the first sensor group; and
a fourth set of instructions to direct the set of switches to place only the sensing elements of the second sensor group in electrical communication with the data acquisition module, so as to direct ones of the second electrical signals generated by the sensing elements of the second sensor group to the data acquisition module.

12. The structural health monitoring system of claim 11 further comprising an electrical interface electrically connecting the signal generation module and the data acquisition module to the sensing elements.

13. The structural health monitoring system of claim 11 wherein the processing unit further comprises a processor and a memory, the memory storing at least one waveform of the first electrical signals, and the processor configured to direct the signal generation module to generate the first electrical signals having the stored waveform.

14. The structural health monitoring system of claim 13, wherein the sets of sensing elements, the signal generation module, and the data acquisition module are each configured for attachment to the structure.

15. The structural health monitoring system of claim 14, wherein the memory and the processor are each configured for attachment to the structure.

16. The structural health monitoring system of claim 11, wherein the processing unit is further programmed to:
(a) select one of the sets of sensing elements;
(b) select a first group of sensing elements from the sensing elements of the selected set of sensing elements;
(c) select a second group of sensing elements;
(d) transmit the first electrical signals only to the first group of sensing elements, so as to generate the stress waves in the structure;
(e) receive the second electrical signals from the second group of sensing elements;
(f) analyze data corresponding to the received second electrical signals, so as to determine a health of an area of the structure corresponding to the selected set of sensing elements;
(g) after (e), select a different one of the sets of sensing elements, and repeat (b)-(f) in order.

17. The method of claim 16 wherein (f) further comprises entering results of the analyzing into a queue.

18. The method of claim 17, further comprising retrieving the results from the queue, and displaying the retrieved results.

19. The method of claim 16 wherein (c) further comprises selecting the second group of sensing elements from the selected set of sensing elements.

20. A method of performing structural health monitoring with a system having a plurality of sensor networks each affixed to a structure, each sensor network having a plurality of sensing elements affixed to the structure, the method comprising:
(a) selecting one of the sensor networks;
(b) selecting first sensing elements of the selected sensor network;
(c) selecting second sensing elements;
(d) transmitting diagnostic signals only to the first sensing elements, so as to generate diagnostic stress waves in the structure;
(e) receiving monitoring signals from the second sensing elements, the monitoring signals corresponding to the generated diagnostic stress waves;
(f) analyzing data corresponding to the received monitoring signals, so as to determine a health of an area of the structure corresponding to the selected sensor network; and
(g) after (e), selecting a different one of the sensor networks, and repeating (b)-(f) in order.

21. The method of claim 20 wherein (f) further comprises entering results of the analyzing into a queue.

22. The method of claim 21, further comprising retrieving the results from the queue, and displaying the retrieved results.

23. The method of claim 20 wherein (c) further comprises selecting the second sensing elements from the selected sensor network.

24. A structural health monitoring system, comprising:
a plurality of sensor networks, each sensor network having a plurality of sensing elements;
a central controller; and
a plurality of local controllers, each in electrical communication with the central controller and one of the sensor networks, and each including at least one of:
a signal generation module configured to generate first electrical signals for generating stress waves in a structure; and
a data acquisition module configured to receive second electrical signals generated by the sensing elements of the associated one sensor network;
wherein the central controller is programmed to select ones of the local controllers and, for each selected local controller, to receive data corresponding to the second electrical signals from the selected local controllers.

25. The structural health monitoring system of claim 24, wherein each of the local controllers is programmed to select a first set of sensing elements from among the sensing elements of its associated sensor network, and to receive the second electrical signals from the first set of sensing elements.

26. The structural health monitoring system of claim 24, wherein each of the local controllers is programmed to select a first set of sensing elements from among the sensing elements of its associated sensor network, and to direct the first electrical signals to the first set of sensing elements.

27. The structural health monitoring system of claim 24, wherein the central controller is further programmed to select a first set of sensing elements from among the sensing elements associated with each selected local controller, so as to direct the second electrical signals from the first set of sensing elements to the associated local controller.

28. The structural health monitoring system of claim 24, wherein the central controller is further programmed to select a first set of sensing elements from among the sensing elements associated with each selected local controller, and to direct the first electrical signals to the first set of sensing elements.

29. The structural health monitoring system of claim 24, wherein each of the local controllers includes the signal generation module, and further comprises a processor programmed to direct its associated signal generation module to generate the first electrical signals.

30. The structural health monitoring system of claim 29, wherein each of the local controllers further comprises a memory storing at least one waveform of the first electrical signals, and wherein the processor is further programmed to direct its associated signal generation module to generate the first electrical signals having the stored waveform.

31. The structural health monitoring system of claim 24:
wherein each of the local controllers further includes a processor programmed to analyze the received second electrical signals so as to generate the data, the data corresponding to a health of an area of the structure corresponding to the associated local controller; and
wherein the processor of each local controller is further programmed to direct the generated data to the central controller.

32. The structural health monitoring system of claim 31, wherein the central controller is further programmed to enter the data from each of the local controllers into a queue, and to retrieve the data from the queue.

33. The structural health monitoring system of claim 24:
wherein the data are the second electrical signals, and each of the local controllers is further programmed to transmit the data to the central controller; and
wherein the central controller further includes a processor programmed to analyze the received data so as to determine a health of an area of the structure corresponding to the local controller that transmitted the data.

34. The structural health monitoring system of claim 33, wherein the central controller is further programmed to enter the data from each of the local controllers into a queue, and to retrieve the data from the queue.
